(19) United States
(12) Patent Application Publication
(10) Pub. No.: US 2018/0139524 A1
(43) Pub. Date: May 17, 2018

(54) ADJUSTABLE HEADPHONES

(71) Applicant: Google Inc., Mountain View, CA (US)

(72) Inventor: Jason Pi, San Jose, CA (US)

(21) Appl. No.: 15/350,227

(22) Filed: Nov. 14, 2016

(51) Int. Cl. H04R 1/10

(52) U.S. Cl. CPC H04R 1/105; H04R 1/1041

(57) ABSTRACT

Aspects of the present disclosure relate to a head-wearable assembly. The head-wearable assembly includes a band that has a first end, a second end, an inner surface, an outer surface, and a generally U-shaped curve between the first end and the second end. On the outer surface of the band is a threaded housing proximal to the first end of the band. The threaded housing has an outer end that faces away from the band and an inner end. The head-wearable assembly also includes an earphone structure, which includes an earphone connected to a threaded arm configured to be coupled with the threaded housing such that the earphone is held at a distance from the first end of the band. When the earphone structure is twisted, the distance between the earphone and the first end of the band is adjusted.

### BACKGROUND

Headphones are designed to hold earphones at or in proximity to a user's ear when worn. Adjustability of headphones is important for adapting to different head types. People's heads vary in size and shape, and people's ears sit at different angles on their heads.

### BRIEF SUMMARY

Aspects of the disclosure provide for a head-wearable assembly. The head-wearable assembly includes a band having a first end, a second end, an inner surface, an outer surface, and a generally U-shaped curve between the first end and the second end; a threaded housing on the outer surface of the band proximal to the first end, the threaded housing having an outer end and an inner end, the outer end facing away from band; and an earphone structure including an earphone connected to a threaded arm, the threaded arm being coupled with the threaded housing such that the earphone is held at a distance from the first end of the band; wherein twisting the earphone structure adjusts the distance between the earphone and the first end of the band.

In one example, the threaded housing is a first threaded housing and the earphone structure is a first earphone structure, and the head-wearable assembly also includes a second threaded housing on the outer surface of the band proximal to the second end; and a second earphone structure configured to couple with the second threaded housing such that the earphone is held at a distance from the second end of the band. In another example, the earphone encloses electronic components configured to receive a signal and produce sound in accordance with the received signal.

In yet another example, the threaded arm is longer than the threaded housing. In this example, the threaded arm has threading along a portion of the threaded arm that substantially matches in length to the threaded housing; and a free end of the threaded arm that is distal from the earphone protrudes from the threaded housing.

In a further example, the outer end of the threaded housing is flush with the first end of the band. In another example, when the distance is shortened when the earphone structure is twisted in a clockwise direction, and the distance is lengthened when the earphone structure is twisted in a counterclockwise direction opposite the first direction.

Other aspects of the disclosure provide for a kit for an adjustable headphone. The kit includes a band having a first end, a second end, an inner surface, an outer surface, and a threaded housing on the outer surface of the band proximal to the first end, the threaded housing having an outer end and an inner end, the outer end facing away from band, the band being generally curved in a U-shape; and an earphone structure including an earphone connected to a threaded arm, the threaded arm being configured to couple with the threaded housing such that the earphone is held at a distance from the first end of the band; wherein twisting the earphone assembly adjusts the distance between the earphone and the first end of the band.

In one example, the threaded housing is a first threaded housing and the earphone assembly is a first earphone structure, and the band also has a second threaded housing on the outer surface of the band proximal to the second end; and the kit further comprises a second earphone structure configured to couple with the second threaded housing such that the earphone is held at a distance from the second end of the band. In another example, the earphone includes electronic components configured to receive a signal and produce sound in accordance with the received signal.

In yet another example, the threaded arm is longer than the threaded housing. In this example, the threaded arm has threading along a portion of the threaded arm that matches in length than the threaded housing. In a further example, the outer end of the threaded housing is flush with the first end of the band. In another example, the threaded housing and the threaded arm are configured to shorten the distance when the earphone assembly is twisted in a clockwise direction, and lengthen the distance when the earphone assembly is twisted in a counterclockwise direction opposite the first direction.

### BRIEF DESCRIPTION OF THE DRAWINGS

FIGS. 1A-D show views of an adjustable headphone in accordance with aspects of the disclosure.

FIGS. 2A-B show views of a band of an adjustable headphone in accordance with accordance with aspects of the disclosure.

FIGS. 3A-C show views of a threaded housing of an adjustable headphone in accordance with aspects of the disclosure.

FIG. 4 shows an earphone structure of an adjustable headphone in accordance with aspects of the disclosure.

FIG. 5 shows an assembly of an earphone structure and a threaded housing in accordance with aspects of the disclosure.

FIGS. 6A-B show pictorial diagrams of ways to adjust an adjustable headphone in accordance with aspects of the disclosure.

FIG. 7 shows an adjustable headphone in accordance with further aspects of the disclosure.

FIG. 8 shows an adjustable headphone in accordance with further aspects of the disclosure.

FIG. 9 shows an adjustable headphone in accordance with further aspects of the disclosure.

### DETAILED DESCRIPTION

### Overview

The technology relates to an adjustable headphone. The adjustable headphone is used to provide a good fit between earphones and a user's ear when the headphone is worn on the user's head. To provide a good fit, the adjustable headphone is configured to adjust the length of the band of the headphone and the angle of the earphone.

The adjustable headphone comprises a band that is generally U-shaped and is configured to be worn on a user's head. At each end of the band, there is a threaded housing that has a cylindrical aperture that is threaded along at least part of the length of the aperture.

The adjustable headphone further comprises at least one earphone structure. The earphone structure includes an earphone connected to a threaded arm. The threading on the threaded arm is placed along at least part of the length of the threaded arm and is configured to couple with the threading in the threaded housing.

When the threaded arm of the earphone structure is assembled with the threaded housing of the band, the adjustable headphone is wearable on a user's head such that the earphone is positioned on or over a user's ear. To adjust the headphone, an earphone structure may be twisted in a clockwise or counterclockwise direction to shorten or lengthen the combined length of the band and the earphones and/or to change the angle the earphones. Once a desired length and/or angle are achieved, the earphone may be left in place to maintain the arrangement for repeated use.

In addition, as discussed in detail below, the features described herein allow for various alternatives.

### Example Systems

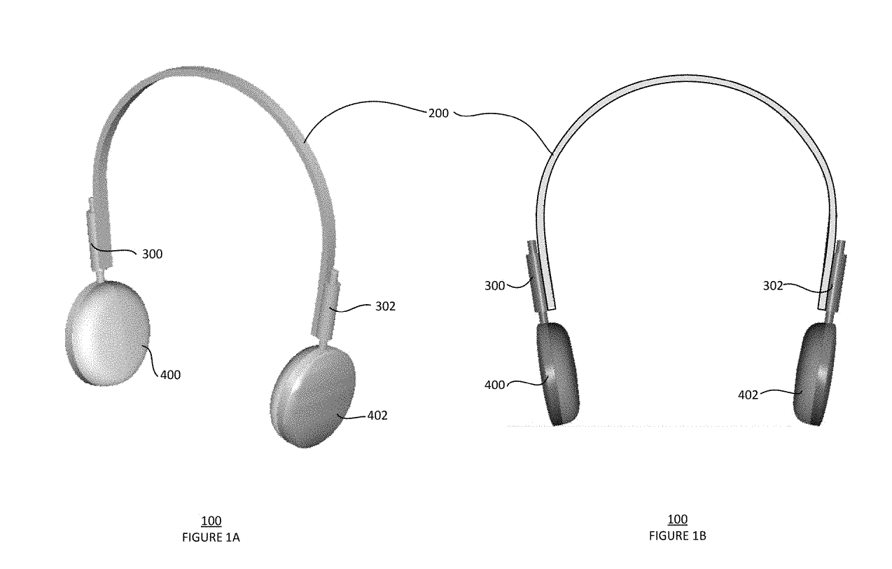

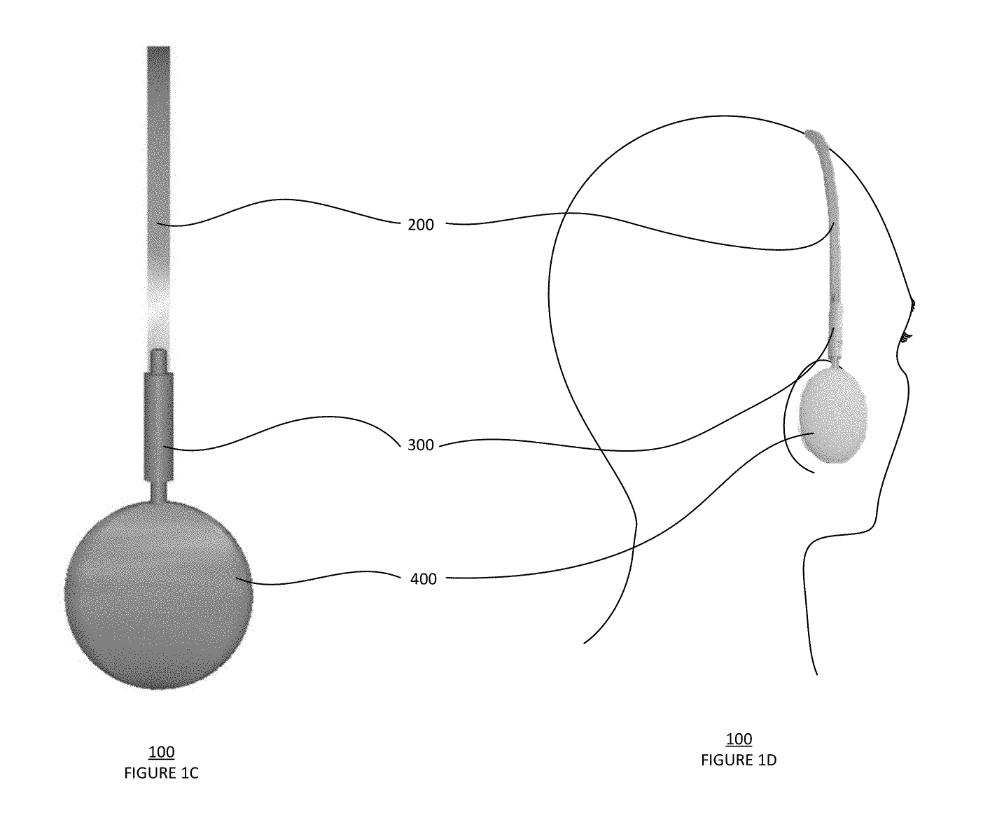

The adjustable headphone is configured to be worn on a user's head and comprises a band, threaded housings, and earphone structures. In FIGS. 1A-D, adjustable headphone 100 comprises band 200, threaded housings 300, 302, and earphone structures 400, 402. FIG. 1A shows a perspective view of adjustable headphone 100. Band 200 is generally curved in a U-shape to fit over the top of a user's head. The material of the band may have elastic properties to provide a comfortable fit on a user's head. At each end of band 200 are threaded housings 300, 302. The threaded housings 300, 302 are an elongated shape that has one side attached along a portion of band 200. The elongated shape may be a cylinder or may be another type of elongated shape. An outer end of each of the threaded housings may be flush with the respective ends of the band, as shown in FIG. 1A. Threaded housings may be formed integrally with the band or may be a separate piece attached to the band using adhesive, connectors, or any known means of attachment. When the threaded housing is a separate piece, the threaded housing may be of the same material as the band or a different material.

Connected to threaded housings 300, 302 are earphone structures 400, 402, respectively. Each earphone structure includes a threaded arm and an earphone. The threaded arm of the earphone structure is a straight, threaded rod configured to fit through and couple with a threaded housing. In adjustable headphone 100, the threaded arms of earphone structures 400, 402 are coupled with threaded housings 300, 302 such that one end of the threaded arms protrude from the respective threaded housings. The other ends of the threaded arms are connected to earphones. The threaded arm of the earphone structure may be connected along a symmetrical axis of the earphone, as shown in FIG. 1A, or may be connected at a different location of the earphone. The earphones of earphone structures 400, 402 are shown in FIG. 1A as on-the-ear, or supra-aural, earphones that comprise circular pads that are configured to be in contact with a user's ears and a circular outer surface to which the circular pads are attached. The earphones are capable of transmitting sound to the user through the circular pads. The pads and outer surfaces of the earphones may be different shapes other than circular, such as elliptical or rectangular, and the earphones may be a different type other than supra-aural, such as over-the-ear, or circumaural, earbuds, etc.

When the earphone structure is assembled to the threaded housing of the band, the earphone may be at a neutral angle, angled to the front, or angled to the back in relation to the band. The earphones of earphone structures 400 and 402 are shown in FIG. 1A at a neutral angle. In the neutral angle, an earphone structure lies with the outer surface of the earphone in a plane substantially parallel to the respective end of the band to which the earphone structure is attached.

FIG. 1B shows the same assembly of adjustable headphone 100 from a front view. Clearly visible from the front view is upside down “U” shape of band 200. Also, FIG. 1B clearly depicts the contact of one side of the threaded housings 300, 302 with band 200 starting from the respective ends of band 200 extending along the outer surface of band 200. The neutral angle of the earphones of earphone structures 400 and 402 in relation to the ends of band 200 is illustrated by how the earphones' outer surfaces are substantially parallel to the band.

FIG. 1C shows the same assembly of adjustable headphone 100 from a side view. In the side view, an alignment of the elements—band 200, threaded housing 300, and earphone structure 400—is shown. The threaded housing 300 aligns with the profile of band 200, and the threaded arm of earphone structure 400, which is inserted in the threaded housing 300, aligns with the threaded housing 300. Because in this example the threaded arm is connected to the earphone of the earphone structure 400 along an axis of symmetry of the earphone's outer surface, which is circular, the earphone of earphone structure 400 is symmetrically positioned in relation to the profile of band 200 and the threaded housing 300.

In other examples, the threaded housing and/or the threaded arm may be at an angle to the band, in which case the earphone may be asymmetrically positioned in relation to one or more of the other elements. The threaded arm also may not be connected to the earphone along an axis of symmetry of the earphone, in which case the earphone may also be asymmetrically positioned in relation to one or more of the other elements. In FIG. 1C, threaded housing 302 and earphone 402 are arranged to mirror the arrangement of threaded housing 300 and earphone 400. In other examples, the arrangement on one side of the adjustable headphone may different from the other side of the adjustable headphone.

In FIG. 1D, the same assembly of adjustable headphone 100 is shown worn on a user's head. When worn on a user's head, band 200 fits over the top of the user's head, and earphone structure 400 extend over or near the user's ear. As shown, the pads of the earphone of earphone structure 400 are in contact with the user's ear underneath the visible outer surface of the earphone. Earphone structure 402 extends over or near the user's other ear on the other side of the user's head.

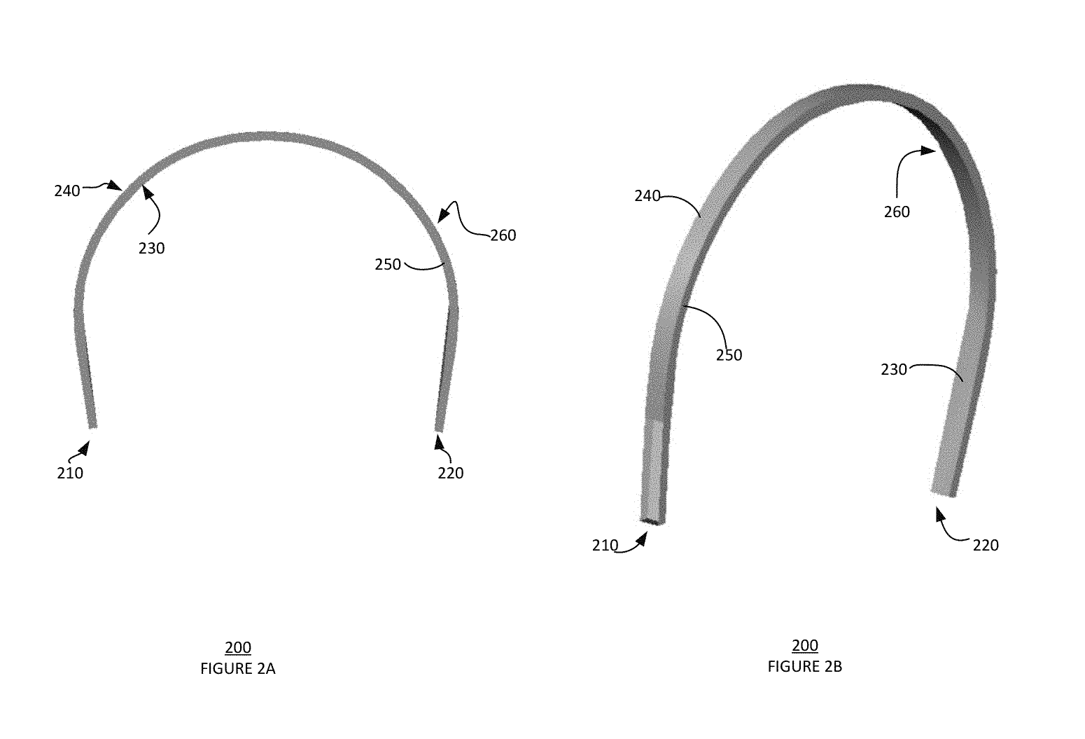

The band of the adjustable headphone is shown in more detail in FIGS. 2A-B. The band may be generally U-shaped and configured to fit over a user's head. As shown from the front view in FIG. 2A, the band 200 has a first end 210 and a second end 220 and a curve between the first end 210 and the second end 220 that is generally U-shaped. The band 200 also has an inner surface 230 and outer surface 240. When worn on a user's head, the inner surface 230 is closer to a user's head than the outer surface 240. Spanning a length of the band 200 are a front surface 250 and a back surface 260. Band 200 may be hollow to store wiring or other electronic components for use in producing and providing audio to a user. FIG. 2B shows band 200 from a perspective view.

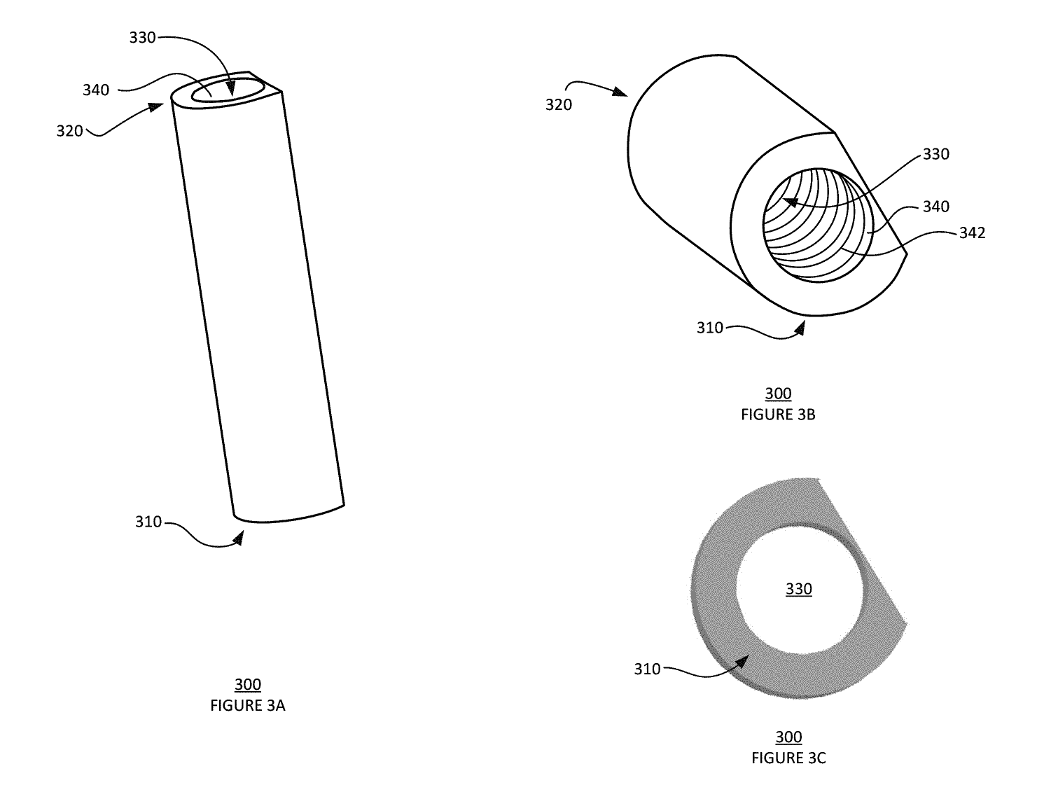

As described above, at each end of the band, there may be a threaded housing. The threaded housing may be an elongated shape positioned on the outer surface of the band. The elongated shape may be, for example, a cylinder, a rectangular prism, or other three-dimensional shape. An outer end of the threaded housing may be proximal to or flush with an end of the band, an inner end of the threaded housing may face the center of the band. FIG. 3A illustrates the threaded housing 300 in more detail from a perspective view. As shown, the threaded housing 300 has an outer end 310 and an inner end 320. The outer end 310 may be lined up flush with the end 210 of band 200, as shown FIGS. 1A-B. The outer end of threaded housing 302 may likewise be flush with the ends of the band of the adjustable headphone and inner ends pointed facing the center of the band 200.

Each threaded housing may include a cylindrical aperture that is threaded along the entire length of the aperture or along a portion of the length of the cylinder. The threading may be, for example, a length corresponding to a difference in potential sizes of human heads. For example, the difference between a length from crown to ear on a head in the 10^{th} percentile and a length from crown to ear on a head in the 90^{th} percentile may be approximately 30 millimeters. The threading in the threaded housing may therefore be approximately 30 millimeters long, ranging between about 15 millimeters and about 50 millimeters. Threaded housing 300 in FIG. 3A has a cylindrical aperture 330 with cylindrical aperture wall 340. In FIG. 3B, another perspective view of threaded housing 300 is shown, in which threading 342 is visible on the cylindrical aperture wall 340 along the length of threaded housing 340.

FIG. 3C shows threaded housing 300 from a head-on view of outer end 310. Cylindrical aperture 330 is shown to pass completely through threaded housing 300. Threaded housing 302 of adjustable headphone 100 may have the same or similar characteristics as threaded housing 300.

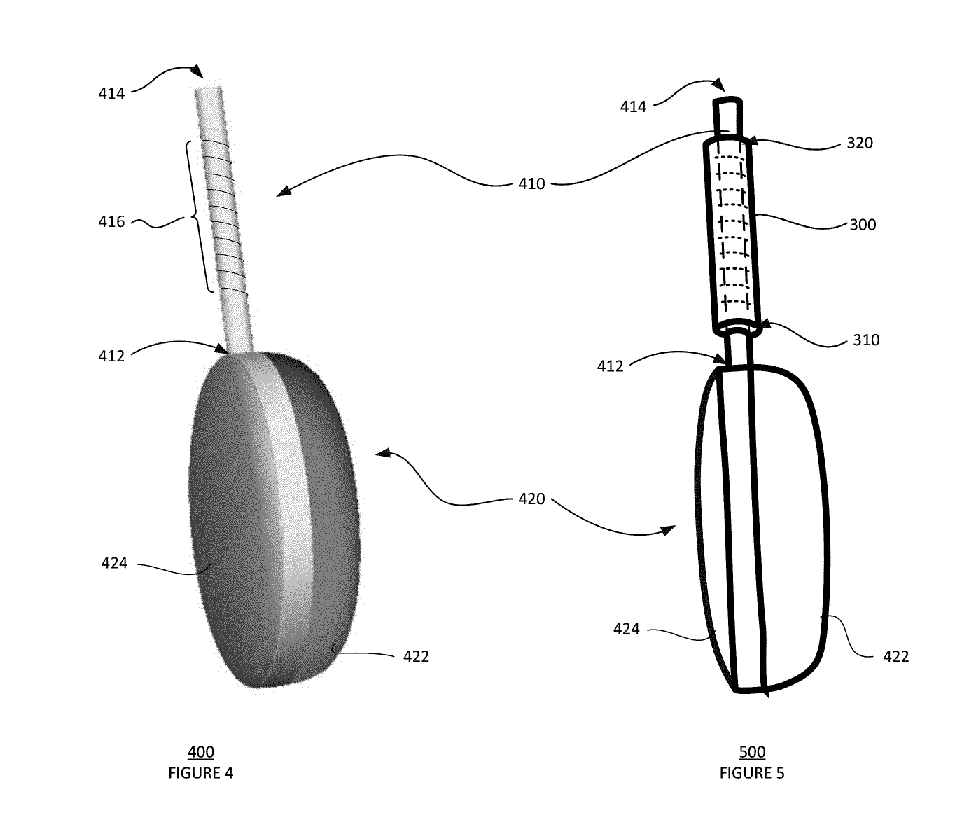

The adjustable headphone further comprises first and second earphone structures, such as earphone structure 400 shown in detail in FIG. 4. An earphone structure may include an earphone connected to a first end of a threaded arm, the second end of the threaded arm being a free end. The length of the threaded arm may be longer than the length of the threaded housing. The threading on the threaded arm is placed along the entire length of the threaded arm or along a portion of the length of the threaded arm and is configured to couple with the threading in the threaded housing. As shown in FIG. 4, earphone structure 400 comprises threaded arm 410 that has first end 412 and second end 414. Threaded arm 410 has a length longer than that of threaded housing 300, and threading 416 is on a portion of the length of threaded arm 410. Earphone 420 is connected to first end 412, and second end 414 is a free end. As depicted, earphone 420 has a pad 422 and an outer surface 424 opposite the pad 422. Pad 422 and outer surface 424 are both circular, but each may be a different shape, such as elliptical, rectangular, or other. When the adjustable headphone 100 is worn on a user's head, pad 422 is configured to contact the user's ear.

The length of the threading on the threaded arm may be related to the length of the threading in the threaded housing. For example, the length of the threading on the threaded arm may match the length of the threading in the threaded housing. Alternatively, the threading on the threaded arm may be shorter or longer than the threading in the threaded housing. The length of threading 416 of threaded arm 410 matches the length of threading 342 of threaded housing 300, as shown in the assembly 500 of FIG. 5. Therefore, the length of threading 416 is also 30 millimeters to correspond with the length of the threading 342.

Electronic components for receiving signal and producing sound may be included in at least one earphone. Earphone 420 includes electronic components for producing sound such that the earphone 420 may provide sound to a user when the adjustable headphone 100 is worn on a user's head. In some examples, the electronic components may be further connected to wiring or other electronic components in the band.

When the earphone structure is assembled with the threaded housing of the band, the adjustable headphone may be worn on a user's head such that the earphone is positioned on or over a user's ear. When assembled, the free end of the threaded arm may be proximal to the inner end of the threaded housing and within the threaded housing or may be protruding from the threaded housing. The earphone may either be against the outer end of the threaded housing or be a distance from the outer end of the threaded housing. In the assembly 500 of earphone structure 420 and threaded housing 300 shown in FIG. 5, threaded arm 410 is coupled with threaded housing 300 such that free end 414 of the threaded arm 410 protrudes from inner end 320 of threaded housing 300. First end 412, which is connected to earphone 420, is a distance from outer end 310 of threaded housing 300.

To adjust the size of the adjustable headphone, an earphone structure may be twisted in a clockwise or counterclockwise direction within the threaded housing. Twisting the earphone may either shorten or lengthen the distance between the earphone and the outer end of the threaded housing. For example, twisting the earphone in a clockwise direction may cause the threaded arm to pass further into the threaded housing and shorten the distance between the earphone and the outer end of the threaded housing. This action may be similar to tightening a screw.

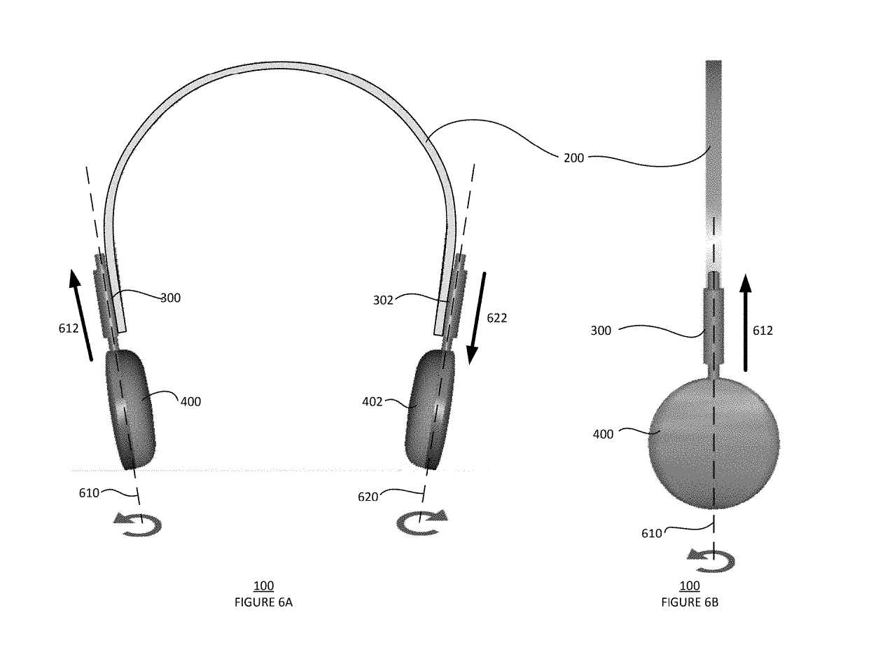

As shown in FIGS. 6A-B, twisting earphone structure 400 in a clockwise direction about axis 610 causes the threaded arm 410 to move in the direction of arrow 612 further into threaded housing 300. The distance between earphone 420 and outer end 310 of threaded housing 300 is shortened as a result. Earphone structure 402 is similarly able to be adjusted when earphone structure 402 is twisted in a clockwise direction about axis 620. Further, twisting the earphone in the counterclockwise direction may cause the threaded arm to move outward in relation to the outer end of the threaded housing and lengthen the distance between the earphone and the outer end of the threaded housing. This action may be similar to loosening a screw.

As shown in FIG. 6A, twisting earphone structure 402 in a counterclockwise direction about axis 620 causes the threaded arm of earphone structure 402 to move in the direction of arrow 622 out of threaded housing 302. The distance between the earphone of earphone structure 402 and the outer end of threaded housing 302 is lengthened as a result. Earphone structure 400 is similarly able to be adjusted when earphone structure 400 is twisted in a counterclockwise direction about axis 610.

An angle of an earphone may also be adjusted by twisting the earphone structure in a clockwise or counterclockwise direction. The angle of the earphone is the angle between the outer surface of the earphone and the inner or outer surface of an end of the band. If a user's ear extends at a particular angle to the user's head, then the angle of the earphone may be adjusted to match the particular angle to provide better fit and increase user comfort. As shown in FIGS. 1A-C, 4, 5, and 6A-B, earphone structures 400 and 402 are shown at a neutral angle. In the neutral angle, an earphone structure lies in a plane substantially parallel to the inner or outer surface of the end of the band to which the earphone structure is attached. From the neutral angle, twisting earphone structure 400 less than 90 degrees in a clockwise direction about axis 610 angles earphone structure 400 towards the front surface of the band. On the other hand, twisting earphone structure 400 less than 90 degrees in a counterclockwise direction about axis 610 angles earphone structure 400 toward the back surface of the band. For earphone structure 402, twisting clockwise angles toward the back surface, and twisting counterclockwise angles towards the front surface.

The adjustable headphone may be configured to maintain a set length and earphone angle. Once a desired distance between the earphone and threaded housing and/or a desired angle of the earphone is reached, the earphone structure may be left in place. The adjustable headphone may be configured so that when the earphone structure is not being twisted, the distance between the earphone and the threaded housing and the angle of the earphone is held in position through the contact of the threaded arm with the threaded housing. In some alternatives, a locking mechanism, such as a bolt over the free end of the threaded arm or a braking mechanism in contact with a part of the threaded arm, may be used to ensure the earphone remains at the desired distance and angle.

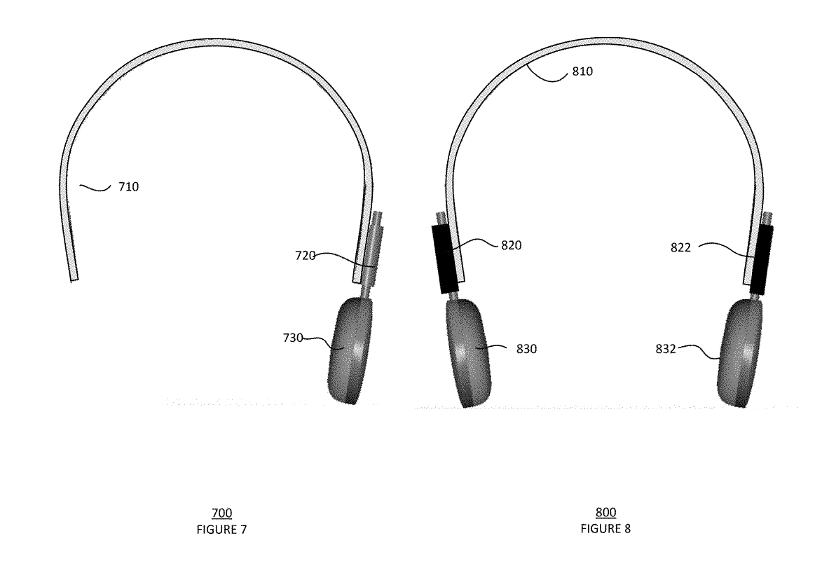

Alternatively, the adjustable headphones may comprise only one earphone structure. FIG. 7 depicts an adjustable headphone 700 that comprises a band 710 configured to fit over a user's head, one threaded housing 720, and one earphone structure 730. The threaded housing 720 and earphone structure 730 of adjustable headphone 700 is configured similar to the threaded housings and earphone structures described above.

In other examples, the threaded housing of the band extends past the ends of the band. FIG. 8 depicts an adjustable headphone 800 comprising a band 810, threaded housings 820 and 822, and earphone structures 830 and 832. As shown, the threaded housings 820 and 822 extend past the ends of band 810.

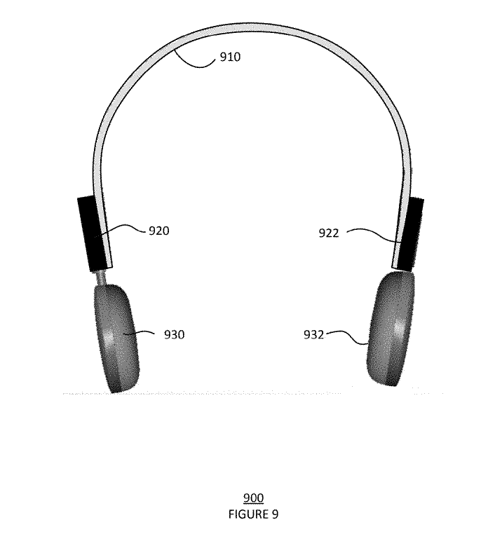

The threaded housing may also alternatively be just as long as or longer than the threaded arm. In this alternative, the free end of the threaded arm remains concealed within the threaded housing no matter the distance between the earphone and the outer end of the threaded housing. As shown in FIG. 9, an adjustable headphone 900 includes a band 910, threaded housings 920 and 922, and earphone structures 930 and 932. The length of threaded housings 920 and 922 are such that when earphone structure 930 or 932 is assembled to contact the outer end of the threaded housing, or have no distance between the earphone and the outer end of the threaded housing, the threaded arm is fully concealed within the threaded housing. The earphone of earphone structure 932, for example, is depicted as in contact with the outer end of threaded housing 922 with the threaded arm of earphone assembly 932 is concealed in the threaded housing 922.

The features of the described above may allow a headphone to be adjustable to fit a variety of shapes and sizes of user's heads. Once adjusted, the headphone may retain the adjusted length and shape so it may be later used by the same user without further adjustment. It may further be easier to control the position of the earphone with respect to the band because twisting the earphone moves the earphone along the threading that has a small and steady incline. Minute adjustments may therefore be made, and the distance between the earphone and the band may be easily predicted and gauged through visible observation.

Unless otherwise stated, the foregoing alternative examples are not mutually exclusive, but may be implemented in various combinations to achieve unique advantages. As these and other variations and combinations of the features discussed above can be utilized without departing from the subject matter defined by the claims, the foregoing description of the embodiments should be taken by way of illustration rather than by way of limitation of the subject matter defined by the claims. In addition, the provision of the examples described herein, as well as clauses phrased as “such as,” “including” and the like, should not be interpreted as limiting the subject matter of the claims to the specific examples; rather, the examples are intended to illustrate only one of many possible embodiments. Further, the same reference numbers in different drawings can identify the same or similar elements.

1. A head-wearable assembly comprising:
a band having a first end, a second end, an inner surface, an outer surface, and a generally U-shaped curve between the first end and the second end;
a threaded housing on the outer surface of the band proximal to the first end, the threaded housing having an outer end and an inner end, the outer end facing away from band; and
an earphone structure including an earphone connected to a threaded arm, the threaded arm being coupled with the threaded housing such that the earphone is held at a distance from the first end of the band;
wherein twisting the earphone structure adjusts the distance between the earphone and the first end of the band.

2. The head-wearable assembly of claim 1, wherein the threaded housing is a first threaded housing and the earphone structure is a first earphone structure, and the head-wearable assembly further comprises:
a second threaded housing on the outer surface of the band proximal to the second end; and
a second earphone structure configured to couple with the second threaded housing such that the earphone is held at a distance from the second end of the band.

3. The head-wearable assembly of claim 1, wherein the earphone encloses electronic components configured to receive a signal and produce sound in accordance with the received signal.

4. The head-wearable assembly of claim 1, wherein the threaded arm is longer than the threaded housing.

5. The head-wearable assembly of claim 4, wherein:
the threaded arm has threading along a portion of the threaded arm that substantially matches in length to the threaded housing; and
a free end of the threaded arm that is distal from the earphone protrudes from the threaded housing.

6. The head-wearable assembly of claim 1, wherein the outer end of the threaded housing is flush with the first end of the band.

7. The head-wearable assembly of claim 1, wherein when the distance is shortened when the earphone structure is twisted in a clockwise direction, and the distance is lengthened when the earphone structure is twisted in a counterclockwise direction opposite the first direction.

8. A kit for an adjustable headphone comprising:
a band having a first end, a second end, an inner surface, an outer surface, and a threaded housing on the outer surface of the band proximal to the first end, the threaded housing having an outer end and an inner end, the outer end facing away from band, the band being generally curved in a U-shape; and
an earphone structure including an earphone connected to a threaded arm, the threaded arm being configured to couple with the threaded housing such that the earphone is held at a distance from the first end of the band;
wherein twisting the earphone assembly adjusts the distance between the earphone and the first end of the band.

9. The kit of claim 8, wherein:
the threaded housing is a first threaded housing and the earphone assembly is a first earphone structure, and
the band also has a second threaded housing on the outer surface of the band proximal to the second end; and
the kit further comprises a second earphone structure configured to couple with the second threaded housing such that the earphone is held at a distance from the second end of the band.

10. The kit of claim 8, wherein the earphone includes electronic components configured to receive a signal and produce sound in accordance with the received signal.

11. The kit of claim 8, wherein the threaded arm is longer than the threaded housing.

12. The kit of claim 11, wherein:
the threaded arm has threading along a portion of the threaded arm that matches in length than the threaded housing.

13. The kit of claim 8, wherein the outer end of the threaded housing is flush with the first end of the band.

14. The kit of claim 8, wherein the threaded housing and the threaded arm are configured to shorten the distance when the earphone assembly is twisted in a clockwise direction, and lengthen the distance when the earphone assembly is twisted in a counterclockwise direction opposite the first direction.
